(19) United States
(12) Patent Application Publication
(10) Pub. No.: US 2021/0155766 A1
(43) Pub. Date: May 27, 2021

(54) COMPOSITIONS AND METHODS FOR ELECTRODE FABRICATION

(71) Applicant: Navitas Systems, LLC, Woodridge, IL (US)

(72) Inventors: Pu Zhang, Woodridge, IL (US); Michael Wixom, Ann Arbor, MI (US)

(21) Appl. No.: 17/045,555

(22) PCT Filed: Apr. 15, 2019
(86) PCT No.: PCT/US2019/027443

§ 371 Date: Oct. 6, 2020

Related U.S. Application Data
(60) Provisional application No. 62/657,211, filed on Apr. 13, 2018.

(51) Int. Cl. C08J 5/18; H01M 4/62; H01M 4/04; H01M 4/505; H01M 4/525; H01M 4/485; H01M 4/58; H01M 10/0525; H01M 10/44

(52) U.S. Cl. CPC C08J 5/18; H01M 4/623; H01M 4/0404; H01M 4/505; H01M 4/525; C08K 3/04; H01M 4/58; H01M 10/0525; H01M 10/44; C08J 2327/18; C08K 2201/001; H01M 4/485

(57) ABSTRACT

Provided are compositions and methods of making and using free-standing electrode films for electrodes by processes that improve upon prior dry process fabrication techniques. Processes are provided for forming an initial free standing film. The initial free standing film is then compressed into an electrode film in the presence of a liquid processing aid whereby the presence of the liquid processing aid reduces the number of roll mill passes to achieve a robust electrode film suitable for use in an electrode with relatively increased film porosity and mechanical strength.

### CROSS REFERENCE TO RELATED APPLICATIONS

This application depends from and claims priority to U.S. Provisional Application No. 62/657,211 filed Apr. 13, 2018, the entire contents of which are incorporated herein by reference.

### STATEMENT OF GOVERNMENT RIGHTS

This disclosure was created with Government support under Contract No. DE-EE0005385 awarded by the U.S. Department of Energy. The Government has certain rights in this invention.

### FIELD

The disclosure relates to batteries and methods for forming electrodes with excellent mechanical properties. More specifically, the disclosure relates to methods for forming thin electrodes suitable for use in lithium ion batteries.

### BACKGROUND

Rechargeable lithium-ion batteries are increasingly used in essential applications such as powering electric/hybrid vehicles, cellular telephones, and cameras. Recharging these battery systems is achieved using electrical energy to reverse the chemical reaction between and at the electrodes used to power the device during battery discharge thereby priming the battery to be capable of delivering additional electrical power.

Typical electrode manufacturing techniques for use in an electrochemical cell include the formation of an active electrode material that is then coated or extruded onto a conductive substrate. The active electrode material is mixed with a binder that serves to associate the active materials. These binders are commonly polymers or resins. To assist in formation of a proper binder, formulations use additives such as solvents, plasticizers, or liquids to dissolve the binder material to form a wet slurry that can effectively be coated onto a conductive substrate. It is beneficial to fibrillate the binder material before or during combination with active material to improve the adhesive properties of the binder. Additives such as activated carbon or other porous carbon materials may be introduced with the binder material in an extruder or other apparatus that serves to fibrillate the binder. When fibrillated, the binder material has improved support for the active material.

In a conventional battery, the polymer binder is dissolved in the solvent and coats the surrounding active particles. When solvent is removed the polymers become sticky and provide the adhesion to a substrate or cohesion between particles. During this process, the solvent remains intermixed with the binder material as a wet slurry. Following extrusion or coating, the wet slurry is then dried to remove the solvent as the continued presence of such additives is commonly detrimental to cell performance. Unfortunately, the drying process is difficult to fully achieve under the short timeframes of common manufacturing conditions thereby requiring fast dry times. This may result in residual additive and impurities remaining in the electrode.

Dry binder formulations have been attempted to reduce or eliminate the drying step by incorporating an additive into the binder that when subjected to high shear mixing serves to fibrillate the binder. The fibrillated binder creates a web-like structure that holds the materials together. Activated carbon (AC) is the typical additive used to promote binder fibrillization; however, more current techniques have improved upon this by the addition of substitute porous carbon materials that may promote improved properties of the electrodes (see e.g. WO/2017/197299). The use of these fibrillization additives reduces the parasitic mass and cost to the electrode that is imparted by activated carbon.

Despite these advancements, relatively poor porosity or mechanical strength result when using dry roll milling processes to fabricate electrodes suitable for use in electrochemical cells. When attempting to produce relatively thin electrochemical electrodes, such as those suitable for use in a lithium ion battery, the electrode material must be passed repeatedly through a roll mill which reduces yield and adds processing cost. As such, new materials and methods are needed to improve mechanical properties and processability of materials used in electrodes of rechargeable batteries.

### SUMMARY

Provided are processes for achieving an electrode that includes a film of electrochemically active material. The processes supplement dry process electrode manufacture techniques to allow for both the advantages of dry process electrode formation such as rapid throughput along with decreasing the time and steps to produce the final electrode film while simultaneously improving porosity and electrode performance. Processes as provided herein include contacting a free standing electrode film formed by a dry process with a liquid processing aid to form a wetted free standing film, and passing said wetted free standing film through a roll mill, wherein said step of passing the wetted free standing film through the roll mill is performed one or more times until an electrode film is formed, the electrode film comprising a final desired thickness of about 75% or less, optionally 50% or less, optionally 25% or less, relative to the initial free standing film, wherein the step of passing said wetted free standing film through the roll mill requires fewer passes than passing an unwetted (e.g. dry) free standing film through the roll mill to form and electrode film comprising said thickness of about 75% or less relative to the initial free standing film. Optionally, passing the wetted free standing film through said roll mill requires 1 to 10 passes through said roll mill to achieve said thickness of about 100 micrometers or less. The resulting electrode film optionally has a porosity of about 35% to about 45%. Optionally an electrode film is characterized by a Young's modulus of about 9.1 N/mm². A liquid processing aid is optionally an alcohol. Optionally, a liquid processing aid is a solvent, the solvent optionally includes a surface tension of about 30 dynes/cm or less at 20 degrees Celsius. Illustrative examples of a liquid processing aid as used in the processes as provided herein include acetone, dimethyl carbonate, ethyl alcohol, ethanol, isopropyl alcohol, or any combination thereof.

### DESCRIPTION OF THE DRAWINGS

FIG. 1 illustrates pore size distribution of compositionally identical electrode films calendered with the use of a liquid processing aid relative to control;

FIG. 2 illustrates half-cell performance of cathodes made using compositionally identical electrode films calendered with the use of a liquid processing aid relative to control;

FIG. 3 illustrates micrographs of the surface of exemplary cathode films produced without a liquid processing aid (A) compared to films produced with a liquid processing aid (B) according to some aspects as provided herein with both presented at 2000× magnification; and

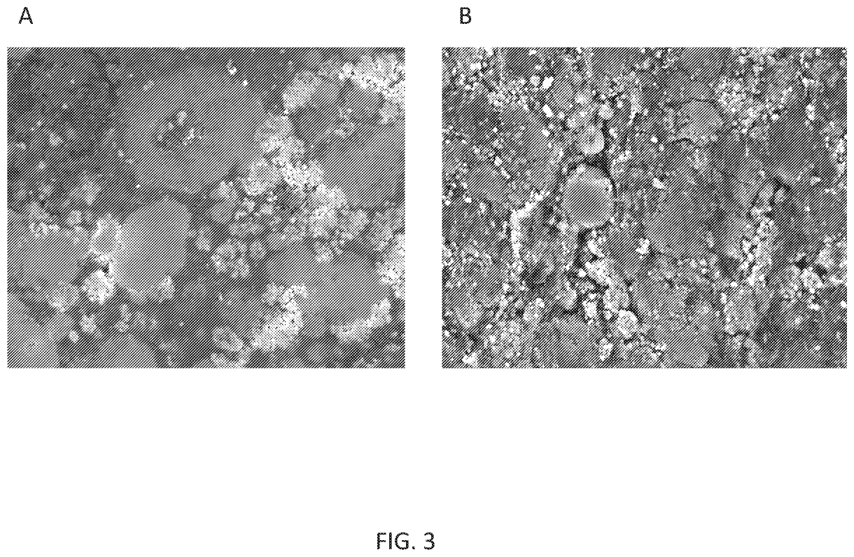

FIG. 4 illustrates cross sectional images (550× magnification) of films processed using a liquid processing aid according to some aspects as provided herein illustrating even distribution of PTFE binder.

### DETAILED DESCRIPTION

Fabrication of electrodes for lithium-ion cells typically involves creating active material layers with a thickness for cathodes of ˜100 μm and anodes of ˜50 μm. It was found that dry processes using porous substitutes for the active carbon historically used for ultracapacitor electrodes helped reduce the amount of binder and solvents required to generate these electrodes, while also reducing residual moisture content. Passing an electrode film through a roll mill, however, introduces stress on the fibrillated binder structure which can lead to tears and cracks that propagate through the free-standing film and leave it unusable. In addition, roll milling reduces the pore size of the film material as is seen by a relatively a narrow pore-size distribution and a smaller average pore-size. The inventors of this disclosure discovered that adding a liquid processing aid to the dry film prior to or while the film was being run through a roll mill, allowed final formation of thin electrodes that have improved porosity and mechanical strength. The addition of the liquid processing aid was also found to reduce the number of passes through the roll mill needed to achieve the desired film thickness thereby improving the overall film properties.

As used herein, “absorbing” can mean: intercalation or insertion or conversion alloying reactions of lithium with the active materials. Absorbing may be referred to herein as “lithiation.”

As used herein, “desorbing” can mean: de-intercalation or de-insertion or conversion de-alloying reactions of lithium with the active materials. Desorbing may be referred to herein as “delithiation.”

As used herein, in the context of the Li-ion cell, “cathode” means positive electrode and “anode” means the negative electrode.

As used herein an “active material” is a material that participates in electrochemical charge/discharge reaction of an electrochemical cell such as by absorbing or desorbing lithium.

As used herein, “fibrillizable” can mean capable of processing into the formation of fibrils.

As used herein, “intermixing” can mean forming a mixture by mixing a mass of ingredients. Intermixing can mean high-shear mixing to effect fibrillization.

As used herein, “mechanical strength” can mean the ability of a material to withstand an applied load without failure or deformation.

As used herein, “surface roughness” can mean the roughness or a surface texture defined by deviations in the normal vector of a real surface from its ideal form. Surface roughness may include complex shapes made of a series of peaks and troughs/pores of varying heights, depths, and spacing.

A process according to some aspects as provided herein includes forming an initial free standing electrode film, optionally by a process that excludes a fluid (e.g. dry process), whereby an active electrode material is calendered to form the initial free standing film, contacting the initial free standing film with a liquid processing aid to form a free standing film, optionally a well wetted free standing film, and passing the wetted free standing film through a roll mill to achieve a final desired thickness whereby the contacting of the initial free standing film with the liquid processing aid results in the need for fewer passes through the roll mill to achieve the final desired thickness relative to the same film material processes in the absence of a processing aid.

In the processes the initial free standing film is contacted with a liquid processing aid. The liquid processing aid is optionally contacted with the initial free standing film in sufficient amount and for a sufficient time to form a wetted, well wetted or substantially saturated standing film. The liquid processing aid is optionally sprayed onto the surface of the initial free standing film, layered onto the initial free standing film, expelled from one or more components of a roll mill, or the initial free standing film is immersed in or layered on top of a liquid processing aid until a wetted free standing film is formed.

A liquid processing aid optionally has a desired evaporation rate, surface tension, vapor pressure, or combination thereof. Optionally, a liquid processing aid has a vapor pressure at 21° C. of 2 millimeters mercury (mmHg) or greater. Optionally a vapor pressure at 21° C. is 10 mmHg or greater. Optionally a vapor pressure at 21° C. is 20 mmHg or greater. Optionally a vapor pressure at 21° C. is 30 mmHg or greater. Optionally a vapor pressure at 21° C. is 35 mmHg or greater. Optionally, a liquid processing aid has a vapor pressure at 21° C. measured in mmHg at or greater than 40, 45, 50, 55, 60, 65, 70, 75, 100, 125, 150, 175, or 200. In some aspects, a liquid processing aid has a vapor pressure at 21° C. measured in mmHg of between 30 and 50.

A liquid processing aid is characterized by a surface tension. Optionally, a suitable liquid processing aid has a surface tension of less than 30 dynes per centimeter (dynes/cm). Optionally, a suitable processing aid has a surface tension measured in dynes/cm of at or less than 29, 28, 27, 26, 25, 24, 23, 22, 21, or 20.

In some aspects, a liquid processing aid has a vapor pressure at 21° C. measured in mmHg at or greater than 40, 45, 50, 55, 60, 65, 70, 75, 100, 125, 150, 175, or 200 and has a surface tension measured in dynes/cm of at or less than 30, 29, 28, 27, 26, 25, 24, 23, 22, 21, or 20. Optionally, a liquid processing aid has both a vapor pressure at 21° C. measured in mmHg at or greater than 2, optionally at or greater than 30, and a surface tension less than 29 dynes/cm.

A liquid processing aid is optionally characterized by an evaporation rate at standard temperature and pressure. An evaporation rate is optionally a moderate evaporation rate defined as greater than 1× and less than 4× relative to butyl acetate. An evaporation rate is optionally a fast evaporation rate defined as at or greater than 4× relative to butyl acetate. An evaporation rate is either fast or moderate in some aspects. Optionally, a liquid processing aid is characterized by a moderate evaporation rate, a vapor pressure at 21° C. measured in mmHg at or greater than 30 and a surface tension less than 29 dynes/cm. Optionally, a liquid processing aid is characterized by a moderate evaporation rate, a vapor pressure at 21° C. measured in mmHg at or greater than 35 and a surface tension less than 24 dynes/cm.

Illustrative examples of a liquid processing aid include an alcohol, a carbonate, a ketone, an acetate, or other suitable processing aid. Specific non-limiting examples of a liquid processing aid include acetone, dimethyl carbonate, ethyl acetate, anisole, ethanol, and isopropyl alcohol. If the temperature of the system is raised during rolling, the surface tension of a processing aid may also change so as to be within the range of 30 dynes/cm or less. An illustrative example of such a liquid processing aid is N-methyl-2-pyrilidone, which was found to be functional at a rolling temperature of about 100° C. or greater. Water is optionally excluded as a liquid processing aid. Characteristics of illustrative processing aids are illustrated in Table 1.

TABLE 1

| | Vapor Pressure | | |
|---|---|---|---|
| Liquid | @ 21° C. | Evaporation rate | Surface Tension |
| Processing Aid | (mmHg) | (Butyl acetate = 1) | (dynes/cm) |
| Acetone | 194 | 5.6 (fast) | 23.3 |
| DMC | 42 | 3.4 (fast) | 28.5 |
| Ethyl Acetate | 78 | 4.2 (fast) | 24 |
| Ethanol | 45.7 | 2.4 (moderate) | 22.3 |
| IPA | 35.1 | 1.5 (moderate) | 21.7 |

Combinations of liquid processing aids may be used simultaneously or sequentially. Illustratively, 1, 2, 3, 4, or more liquid processing aids may be used.

A step of passing a free standing film through a roll mill is performed at a calender pressure. A calender pressure is optionally from 1000 pounds per linear inch to 7000 pounds per linear inch.

A step of passing a wetted free standing film through a roll mill is optionally performed at a rolling temperature. A rolling temperature is optionally from about 0° C. to about 100° C., or any value or range therebetween. A rolling temperature is optionally about 25° C. to about 100° C., optionally about 25° C. to about 30° C. A rolling temperature is optionally about 25° C., about 50° C., or about 100° C.

An initial free standing film is optionally substantially saturated or is well wetted with a liquid processing aid prior to or during the step of passing the free standing film through a roll mill. As used herein, saturated is defined as liquid processing aid contacting one or both surfaces of the free standing film in sufficient quantity that the addition of any additional liquid processing aid will not increase the amount of liquid processing aid associated with or within the free standing film.

When a liquid processing aid is used the number of passes to achieve a desired thickness of a final electrode film is optionally fewer than 10, optionally fewer than 9, optionally fewer than 8, optionally fewer than 7, optionally fewer than 6, optionally fewer than 5, optionally fewer than 4, optionally fewer than 3, optionally fewer than 2 with a calender pressure from 1000 pounds per linear inch to 7000 pounds per linear inch. In some aspects, a final desired thickness may be achieved by passing the saturated electrode film through the roll mill with one pass.

An advantage of using a liquid processing aid with calendering an initial film to produce a final electrode film is that the reduced number of passes through a roll mill improves the porosity, tortuosity, and mechanical strength of the final film thereby allowing for more efficient function when used as an electrode, the use of thicker electrode films, or both. As such, in some aspects, an electrode film following calendering with a liquid processing aid as described herein optionally has an average pore diameter of greater than about 30 nm, optionally greater than about 35 nm, optionally greater than about 40 nm, optionally greater than about 45 nm, optionally greater than about 50 nm. The increase in average pore diameter results from an increased number of pores having a large diameter (100 nm) and fewer pores having a small diameter (30 nm or lower). The use of the word “diameter” to describe pore size is not intended to mean a pore opening is perfectly circular. Diameter is an average cross sectional dimension of the pore opening.

A liquid processing aid is optionally removed prior to laminating an electrode film to a current collector. Removal is optionally by drying in a desired atmosphere at a desired temperature. Optionally a liquid processing aid is removed by drying in air at ambient temperature of about 25° C. Optionally, the liquid processing aid is removed by heating the electrode film such as by convention or exposure to infrared energy.

An electrode film formed by the process of calendering with a processing aid as described herein optionally has a pore diameter distribution from about 3 nm to about 20 μm or greater. Optionally, a pore diameter distribution from about 3 nm to about 18 μm, optionally a pore diameter distribution from about 10 nm to about 20 μm or greater.

An overall porosity of an electrode film is optionally 25% or greater, optionally 35% or greater, optionally 45% or greater, optionally 35% to 45%, optionally 30% to 35%, optionally about 30% to about 45%.

An electrode film formed by the use of a liquid processing aid as described herein is characterized by a lower tortuosity relative to a film that is not calendered in the presence of a processing aid. An electrode film optionally has tortuosity of 7 or less, optionally 6 or less, optionally 5 or less, optionally 4 or less.

The process includes forming an initial free standing film that includes one or more active electrode materials. An active electrode material is optionally a metal oxide, a metal phosphate, a sulfate, or other suitable electrochemically active material where an electrochemically active material is one that is capable of absorbing and desorbing lithium. Optionally, an active electrode material is a lithium metal oxide, a lithium metal phosphate, or other. Illustrative examples include but are not limited to Nickel Manganese Cobalt (NMC622, NMC811, NMC532) (a.k.a. NCM or NMC), Lithium Sulfur, Lithium Manganese Spinel (LMO), Lithium Nickel Manganese Spinel (LNMO), Lithium Nickel Cobalt Aluminum Oxide (NCA), Lithium Iron Phosphate (LFP), Lithium Iron Manganese Phosphate (LMFP), Lithium Cobalt Oxide (LCO), and graphite formulas, or combinations thereof. In particular examples, an electrochemically active material is one or more LMFP or NMC materials, optionally at the exclusion of one or more other materials.

The processes as provided herein may be used with electrochemically active material such as those produced by dry processes as described in WO/2017/197299 or U.S. Pat. Nos. 7,352,558, 7,384,433, 7,295,423, and 8.072.734.

In the formation of an initial free standing film prior to calendering in the presence of a liquid processing aid as provided herein, the initial free standing film is formed by a dry process which is absent solvent or the formation of a slurry. As such, an initial free standing film includes a solid processing additive. Optionally, in the processes as used herein a solid processing additive is not activated carbon. A solid processing additive optionally has a surface roughness on a dimensional scale that is within 10% to 250% of that found in PTFE fibers. Such a surface is rough on a dimensional scale where roughness is defined as a plurality of hills and valleys on the surface of the solid processing additive. In some aspects of the disclosure, a surface roughness defines a porous surface structure, optionally a surface structure having high porosity. High-porosity with respect to a solid processing additive is defined as a pore diameter of about 10 nm to about 1000 nm having a cumulative pore volume of about 0.8 mug to about 2.5 mL/g, or having a porous structure with a density of about 1500 kg/m³ to about 2500 kg/m³. Optionally, the cumulative pore volume is about 1.0 mL/g to about 2.5 mL/g, optionally about 1.2 mL/g to about 2.2 mL/g, optionally with a pore diameter of about 10 nm to about 1000 nm. In some aspects, the solid processing additive has a cumulative pore volume of optionally of or greater than 0.8 mL/g, optionally about 0.9 mL/g, 1.0 mL/g, 1.1 mL/g, 1.2 mL/g, 1.3 mL/g, 1.4 mL/g, 1.5 mL/g, 1.6 mL/g, 1.7 mL/g, optionally 1.8 mL/g, 1.9 mL/g, 2.0 mL/g, 2.1 mL/g, 2.2 mL/g, 2.3 mL/g, 2.4 mL/g, 2.5 mL/g. For comparison, activated carbon has a pore volume of about 0.9 mL/g. The solid processing additive for example, without limitation, may have a porosity of about 30 vol % to about 40 vol %, or any value or range therebetween, optionally about 35 vol % to about 40 vol %, optionally about 30 vol %, 31 vol %, 32 vol %, 33 vol %, 34 vol %, 35 vol %, 36 vol %, 37 vol %, 38 vol %, 39 vol %, 40 vol %.

In some aspects of the disclosure, the solid processing additive is capable of maintaining porosity during calendering. For example, porosity of the solid processing additive decreases by less than half of the porosity before calendering. A solid processing additive optionally has a mechanical strength sufficient to survive high energy mixing typically used in the art to fibrillize a binder. As used herein, sufficient mechanical strength of a solid processing additive may be defined as the ability of the additive not to break apart during intermixing and produce fines.

These rough and/or porous solid processing additives significantly improved overall processability and mechanical strength when electrode materials are formed using a low or non-solvent process such as that described in U.S. Pat. No. 8,072,734.

Examples of a solid processing additive as used herein include active carbon (AC), or a silica-templated high-porosity optionally graphitized carbon material with particle size distribution optionally peaking in about the 3 micrometer (m) to about 5 μm range. In some aspects, the BET area of the solid processing additive is much less than conventional AC and the material is not activated and thus is less hydrophilic than AC. The graphitization process imparts mechanical strength comparable to the pyrolized highly-cross linked cellulosic precursor sources used to form AC. An illustrative example of a solid processing additive such as porous carbon is sold as POROCARB by Heraeus Quarzglas GmbH & Co. KG, Kleinostheim, Germany.

A manufacturing method for exemplary porous carbon particles for use as a solid processing additive herein may be found in German published patent application DE 10 2010 005 954 A1 and U.S. Pat. No. 9,174,878. In general, a porous metal oxide template of agglomerated or aggregated metal oxide nanoparticles is first produced by hydrolysis or pyrolysis of a starting compound by means of a soot deposition process. The pores are infiltrated with a carbon precursor substance. After carbonization, the template is again removed by etching. What remains is a porous carbon product having a hierarchical pore structure with platelet-like or flake-like morphology.

In some aspects of the disclosure, a solid processing additive is a hard carbon with mechanical properties similar to activated carbon with regard to properties such as particle strength, particle morphology, or surface roughness, which may contribute to the electrode processability, but with lower porosity, lower surface area (e.g., as measured by gas adsorption), or less hydroscopic than activated carbon. An illustrative example of a hard carbon is sold as LBV-1 Hard Carbon from Sumitomo Bakelite Co., LTD. Such a material may be obtained from pyrolizing highly cross-linked cellulosic precursors. Whereas commercial ‘activated carbon’ materials are subjected to a pore-forming activation process prior to particle size reduction and classification, the desired exemplary solid processing additive may be formed by excluding the activation process. The exemplary solid processing additive optionally has a BET surface area <200 m²/g and preferably <20 m²/g, compared to areas >800 m²/g for commercial activated carbon.

A solid processing additive has a particle diameter. It is preferred that particle diameters of 50 μm or less are used. Optionally, a solid processing additive has an average particle diameter of 1 μm to 50 μm, optionally 1 μm to 30 μm, optionally 1 μm to 25 μm, optionally 1 μm to 20 μm, optionally 1 μm to 5 μm, optionally 3 μm to 10 μm.

A solid processing additive is optionally present at a concentration of 20 weight to 75 weight percent the amount of binder used to form an electrode. Optionally, the solid processing additive is present at a weight percent of 30 percent to 60 percent, optionally, 40 percent to 70 percent, optionally 50 percent to 70 percent, the amount of binder. In some aspects of the disclosure, the solid processing additive is used to the exclusion of activated carbon. Optionally, the solid processing additive is used in place of some amount of activated carbon, but the solid processing additive and the activated carbon are used together.

A solid processing additive is optionally present at a concentration relative to an overall electrode material. An overall weight percent concentration of solid processing additive is optionally from 2 percent to 10 percent, optionally from 2 percent to 6 percent, optionally from 4 percent to 8 percent, optionally at 5 percent. In some aspects of the disclosure, the overall concentration of solid processing additive is optionally greater than or equal to 5 weight percent, optionally 5 weight percent to 8 weight percent to greater, optionally when blended with an active electrode material such as LFP, NMC, LMFP, or the like.

In some aspects, an electrode film material includes a conductive carbon. It is appreciated that activated carbon and conductive carbon are each conductive to relative degrees. Generally, for electrochemical purposes however, conductive carbons are small (<1 μm) materials that disperse readily and/or may dry coat the electrode materials to provide electronic linkages through the electrode. (e.g., electron transport via percolation model). As such, conductive carbon as used herein is not activated carbon (AC) as is otherwise described herein. The dispersed conductive carbon network may be described in some cases as “chain of pearls.” In other cases conductive carbons may be high aspect ratio fibers or platelets that can wrap powders and/or form a web type network. In some aspects, electrodes may use combinations of conductive carbons. On the other hand, activated carbon generally refers to very high surface area microporous materials. Conductive carbons may or may not be porous but in many cases are also high surface area but with more of the surface area due to exterior of small particles rather than internal pore volume as is the case for activated carbons. Commercial activated carbons are generally much larger particles than conductive carbons.

Binders such as polytetrafluoroethylene (PTFE) or polyvinylidiene fluoride (PVdF) powders may be blended into active materials and fibrillized under high-shear. A binder material optionally includes a fibrillizable fluoropolymer, optionally, polytetrafluoroethylene (PTFE). Other possible fibrillizable binders include ultra-high molecular weight polypropylene, polyethylene, co-polymers, polymer blends and the like. Optionally, a binder material is a combination of any of the foregoing. After fibrillization, the electrode film materials can be processed into an initial free-standing film by feeding into a roll mill.

Optionally, an electrode film material for use in forming an initial free standing film is formed by combining an active electrode material, a solid processing aid and a binder in a particular order. It was discovered that dispersing the solid processing additive in the active electrode material or the fibrillizable binder and subsequently intermixing the previously omitted active electrode material or the fibrillizable binder improved the processing characteristics and electrochemical properties of the resulting electrodes. As such, the combination of elements of a resulting film required particular order and dispersion properties whereby intermixing of the solid processing additive with the entire set of materials was non-optimal. Great improvements in processability of the electrode material is achieved by first intermixing the solid processing additive with either the binder or the active electrode material prior to combination with the other.

In some aspects of this disclosure, forming the free flowing powder of electrode film material includes combining an active electrode material and solid processing additive. The active material optionally comprises any such electrochemically active material as described herein, optionally 100 wt % NMC, 80 wt % NMC, 60 wt % NMC, 50 wt % NMC, 40 wt % NMC, or 20 wt % NMC. Optionally, the active material blended with the NMC is LMFP. The processing additive optionally comprises a porous carbon additive sold as POROCARB. The solid processing addictive may be dispersed with the active electrode material by intermixing. Intermixing may occur from about 5,000 RPM to about 500 RPM for 1 minute, optionally from about 2,000 RPM to about 4,000 RPM for 1 minute, optionally at about 3,000 RPM for 1 minute. The intermixing may include a cool down for 5 minutes at about −20 degrees Celsius to about 10 degrees Celsius, optionally at −20 degrees Celsius, −10 degrees Celsius, 0 degrees Celsius, or 10 degrees Celsius. The intermixing and cool down may be repeated 1, 2, or 3 times to disperse the solid processing additive in the active electrode material. In some aspects, the intermixing and cool down may be repeated until the a tap density is measured from about 0.99 g/cm³ to about 1.1 g/cm³. A fibrillizable binder may then be added to the solid processing additive and active electrode material mixture. The fibrillizable binder is intermixed from about 25,000 RPM to about 10,000 RPM, optionally at about 18,000 RPM for 30 seconds followed by a cool down for 10 minutes at about −20 degrees Celsius to about 10 degrees Celsius, optionally at −20 degrees Celsius, −10 degrees Celsius, 0 degrees Celsius, or 10 degrees Celsius. In some aspects, the fibrillizable binder is intermixed from about 2,000 RPM to about 4,000 RPM, optionally at about 3,000 RPM for 1 minute followed by a cool down for 10 minutes at about −20 degrees Celsius to about 10 degrees Celsius, optionally at −20 degrees Celsius, −10 degrees Celsius, 0 degrees Celsius, or 10 degrees Celsius. The high shear mixing serves to fibrillate the binder. The intermixing and subsequent cool down of the fibrillizable binder with the solid processing additive and active electrode material mixture may be repeated 1, 2, 3, 4, 5 or 6 times to form an electrode film material in a free flowing powder form. In some aspects, the intermixing and cool down may be repeated until the a tap density is measured from about 0.73 g/cm³ to about 0.81 g/cm³.

In other aspects of the disclosure, forming the free flowing powder of the electrode film material includes combining a fibrillizable binder and solid processing additive prior to combination with an active material. The solid processing addictive may be dispersed with the fibrillizable binder by intermixing. The fibrillizable binder may be intermixed from about 25,000 RPM to about 10,000 RPM, optionally at about 18.000 RPM for 30 seconds followed by a cool down for 10 minutes at about −20 degrees Celsius to about 10 degrees Celsius, optionally at −20 degrees Celsius, −10 degrees Celsius, 0 degrees Celsius, or 10 degrees Celsius. In some aspects, the fibrillizable binder is intermixed from about 2,000 RPM to about 4,000 RPM, optionally at about 3,000 RPM for 1 minute followed by a cool down for 10 minutes at about −20 degrees Celsius to about 10 degrees Celsius, optionally at −20 degrees Celsius, −10 degrees Celsius, 0 degrees Celsius, or 10 degrees Celsius. The high shear mixing serves to fibrillate the binder. The intermixing and subsequent cool down of the fibrillizable binder with the solid processing additive may be repeated 1, 2, 3, 4, 5 or 6 times to fibrillize the binder and disperse the solid processing additive with the fibrillizable binder. In some aspects, the intermixing and cool down may be repeated until the a tap density is measured from about 0.73 g/cm³ to about 0.81 g/cm³. An active electrode material may then be added to the solid processing additive and fibrillizable binder and intermixed. Intermixing may occur from about 5,000 RPM to about 500 RPM for 1 minute, optionally from about 2,000 RPM to about 4,000 RPM for 1 minute, optionally at about 3,000 RPM for 1 minute. The intermixing may be followed by a cool down for 5 minutes at about −20 degrees Celsius to about 10 degrees Celsius, optionally at −20 degrees Celsius, −10 degrees Celsius, 0 degrees Celsius, or 10 degrees Celsius. The intermixing and cool down may be repeated 1, 2, or 3 times to disperse the solid processing additive and fibrillizable binder combination in the active electrode material to form an electrode precursor material in a free flowing powder form. In some aspects, the intermixing and cool down may be repeated until the a tap density is measured from about 0.99 g/cm³ to about 1.1 g/cm³.

The electrode film material is appreciated to be a free flowing powder. The free flowing powder is optionally sieved to a desired particle size as measured by the size of the particles able to pass through the sieve as desired. The electrode film materials prior to or when formed into an initial electrode film preferably contain no more water or other liquid solvent than the ambient atmosphere, preferably less than 1% of any liquid including for example solvents, water, ethanol, or the like. The improved processability of the materials formed using the solid processing additive and by methods as described herein is further enhanced by the dry aspects of the materials that provide more rapid overall electrode manufacture.

The electrode film material may be subsequently passed through a 355 micron sieve before being calendered into an initial free-standing film. Once the electrode precursor material is formed, the electrode precursor material is fed into a roll mill and calendered to form an initial free-standing film. The initial free-standing film may be formed by calendering the free flowing electrode film material at a roll temperature and roll speed under a hydraulic pressure. The roll temperature may be from about room temperature (20 degrees Celsius) to about 180 degrees Celsius. A higher the roll temperature may result in a thinner free-standing film on the first pass compared to a lower temperature. Additionally, the roll speed may be set from about 0.17 meters per minute to about 1.3 meters per minute. A slower roll speed may result in a thinner initial free-standing film on the first pass compared to a faster roll speed. A hydraulic pressure of about 1,000 pounds per square inch (psi) to about 7,000 psi may be used. A higher pressure may result in a thinner initial free-standing film on the first pass compared to a lower pressure. Additional passes through the roll mill may continue to reduce the initial free standing film thickness until desired thickness and loading are obtained. In some aspects of the disclosure, an example, without limitation, an initial free standing film thickness may be about 150 μm to about 400 μm, optionally 150 μm to 200 μm. In some aspects of the disclosure, an example, without limitation, desired loading may be about 19 mg/cm² to about 21 mg/cm², optionally about 19 mg/cm², optionally about 20 mg/cm², or optionally about 21 mg/cm². An initial free standing film thickness may be from about 40 μm to about 400 μm, optionally about 50 μm to about 100 μm, optionally about 100 μm or less, optionally about 50 μm or less.

Following formation of the initial free standing film, contacting with the liquid processing aid and formation of the electrode film, in some aspects, the electrode film is then laminated to a current collector, optionally a current collector including a conductive metal. The current collector may be an aluminum foil, a copper foil or optionally another conductive metal foil. Lamination may occur by rolling the electrode film together with the metal foil current collector at a roll temperature and roll speed under a hydraulic pressure. The roll temperature is optionally about 100 degrees Celsius, about optionally 80 degrees Celsius, optionally about 90 degrees Celsius, optionally 80 degrees Celsius to 100 degrees Celsius. It is appreciated that the higher the roll temperature the greater the likelihood of blistering and poor adhesion. Similarly, the lower the roll temperature the worse the adhesion. Additionally, the roll speed may be from about 0.17 meters per minute to about 1.3 meters per minute, optionally about 0.5 meters per minute. Finally, the hydraulic pressure may be set from about 500 psi to about 2,000 psi. The pressure is set to promote adhesion to the substrate but not such that the chemical properties, for example loading and porosity, are altered. When the pressure is set too high the chemical properties are effected, but when the pressure is set too low adhesion may not occur.

The processes and electrode films produced thereby achieve a dry manufacture method that creates excellent electrochemical properties to resulting electrodes suitable for use in lithium ion or other cells.

Various aspects of the present disclosure are illustrated by the following non-limiting examples. The examples are for illustrative purposes and are not a limitation on any practice of the present disclosure. It will be understood that variations and modifications can be made without departing from the spirit and scope of the disclosure. Reagents and materials illustrated herein are obtained from commercial sources unless otherwise indicated.

### EXPERIMENTAL

### Example 1

Electrode active materials used in a cathode are formed using the following amounts of materials with percent being weight percent:

TABLE 2

| | | | Solid | | |
|---|---|---|---|---|---|
| | Active Material | | Processing | Conductive | |
| | LMFP | NCM | additive | Carbon | Binder |
| Baseline | 43.5% | 43.5% | 5% | 3% | 5% |

Electrodes are formed by mixing the electrochemically active material, solid processing additive and conductive carbon and spinning the mixture at 3,000 RPM for 1 min. The spin is repeated two more times with a 5 min cool down at −20° C. in between spins. Binder is added to the mixture and blended at 18,000 RPM for 30 sec. The blending is repeated five more times with a 10 min cool down at −20° C. in between blends. Finally, the blended material is passed through 355 micron sieve.

As a control, initial free standing electrode films are then formed by passing the sieved material produced by the above mixing procedure through a vertical roll mill in an environment at about 130° C. to obtain initial free-standing film. The resulting initial free standing fill is then passed through a horizontal roll mill in an environment at about 50° C. or where the initial free standing film is heated to about 50° C. and passed through the mill aid until desired thickness and loading are obtained; and for baseline studies without further processing in the absence of a liquid processing aid. Heating any film or environment may be performed by any possible processes, illustratively by subjecting to infrared radiation (IR) or other known heating process.

For lamination, a primed current collector (e.g., Al foil) is placed between two electrode films or contacted with a single electrode film and passed through a horizontal mill heated to 80° C.

Film Fabrication with a processing aid—The above preparation and formation of the initial free standing film as per the above is repeated with the exception that the initial free standing film is saturated with isopropyl alcohol (IPA) as it passes through the horizontal roll mill at 50° C. and compressing under 4000-7000 PSI of pressure, until desired thickness and loading are obtained. These parameters were chosen to limit the number of passes needed to reach a 100 micron freestanding film (Tables 3 and 4), 50 roll temperatures where used to increase the evaporation rate of IPA as the film was extruded through the mill. The mill rolls where running at 0.65 meters/m to obtain 100 microns in one pass, faster speeds result in less thickness reduction per pass. For lamination to form electrodes, a primed Al foil is placed between two free standing films or contacted with one free standing film and passed through a horizontal mill heated to 100° C. in the web direction.

TABLE 3
Amount of IPA added and or removed prior to film reduction.

| Film Saturation | Drying before | # of passes to reach ~100 |
|---|---|---|
| level | calender | micron thickness |
| None | None | 11 |
| Saturated | Solvent removed | 8 |
| | with IR heat | |
| Saturated | None | 1 |

TABLE 4
Number of passes to reach 100 micron free-standing
film target using IPA as processing aid.

| Calender Temperature | Calender Pressure | # of passes to reach ~100 |
|---|---|---|
| (° C.) | (PSI) | micron thickness |
| 100 | 7000 | 2 |
| | 4000 | 2 |
| | 1000 | 2 |
| 50 | 7000 | 1 |
| | 4000 | 1 |
| | 1000 | 2 |
| RT | 7000 | 1 |
| | 4000 | 1 |
| | 1000 | 2 |

Similar processes are used for the formation of an anode. Anodes are formed including 84% graphite, 4% AC or processing additive, 4% conductive carbon, 8% binder (PTFE or PTFE/PVDF/PE blend). Anodes are formed by processes similar to the cathode material, calendering the powder mixture to form a stand-alone film at room temperature (porosity ˜35%); laminating the film onto a Cu foil (porosity ˜25%).

In the cathode, the advantages of using a liquid processing aid vs. no liquid processing aid are improved processability and mechanical strength in ‘dry process’ electrodes based on fibrillized PTFE binders. The advantages versus using no liquid processing aid are the possibility of using less additive, less binder, faster electrolyte wetting, and improved electrode uniformity following the milling operation. In addition, wetting with a liquid processing aid as provided herein promotes a higher porosity in the film which would better facilitate ion transport and improve the electrical current density and rate retention for an electrode of given thickness and porosity. The improved tensile properties allow for reel-to-reel processing in a large scale operation.

The number of passes through the horizontal roll mill are significantly reduced by use of the liquid processing aid. For IPA and the above cathodes comparative results to achieve a 100 micrometer thick film are presented in Table 5.

TABLE 5
Number of passes through roll mill after initial free standing film
is formed; porosity values obtained through geometric calculations.

| | Processing | # of passes to | Loading | |
|---|---|---|---|---|
| Mix | Aid | reach 100 μm | mg/cm² | Porosity |
| Baseline | NONE | 11 | 23.0 | 28% |
| Baseline | SPA | 1 | 22.2 | 35% |

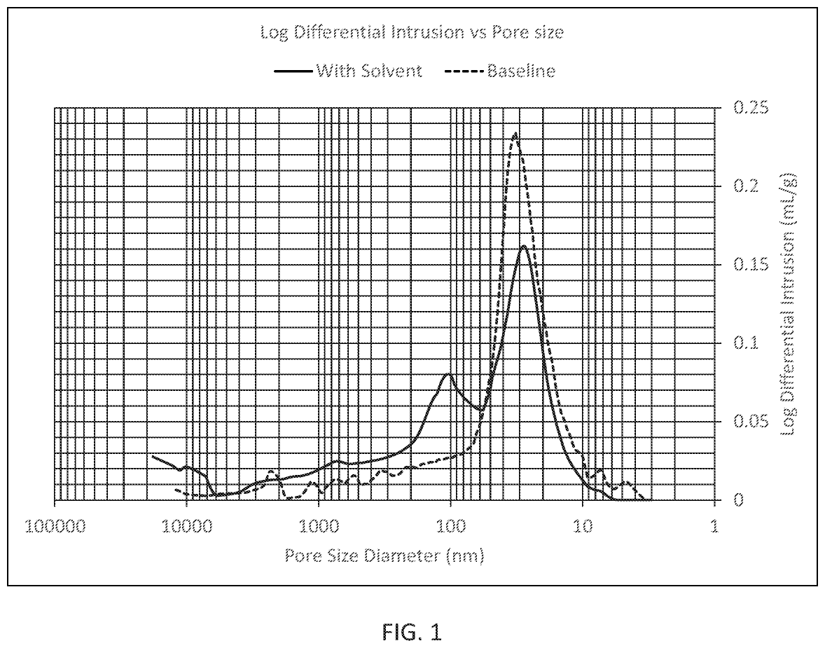

Increase in porosity, pore size distribution and average pore diameter are analyzed by mercury intrusion. A plot of pore size distribution of films calendered with the use of a liquid processing aid as illustrated in FIG. 1 indicates an increase in the amount of larger pore structures (100 nm) and a decrease in the amount of smaller pore structures (30 nm). The resulting higher proportion of large pore sizes allows for enhanced rate retention in the resulting cathodes and the formation of thicker functional electrodes.

TABLE 6
Mercury porosimetry data of free standing
cathodes, not laminated to substrate.

| | Baseline | Baseline formulation |
|---|---|---|
| | formulation | fabricated with IPA |
| Porosity | 30% | 35% |
| Pore Size Distribution | 3 nm-12 μm | 3 nm-18 μm |
| Avg. Pore Diameter | 28.2 nm | 52.7 nm |
| Tortuosity | 7.8 | 4.52 |

An increase in the elongation of free-standing films and a reduction in the Young's Modulus can be seen through tensile testing as illustrated in Table 7.

TABLE 7
Tensile measurements of 100 micron free-standing cathode film.

| | Force @ | Elongation @ | Young's |
|---|---|---|---|
| | Peak (N) | peak (mm) | Modulus (N/mm²) |
| Baseline | 6.160 | 0.092 | 645.860 |
| Baseline with IPA | 0.761 | 1.267 | 9.188 |

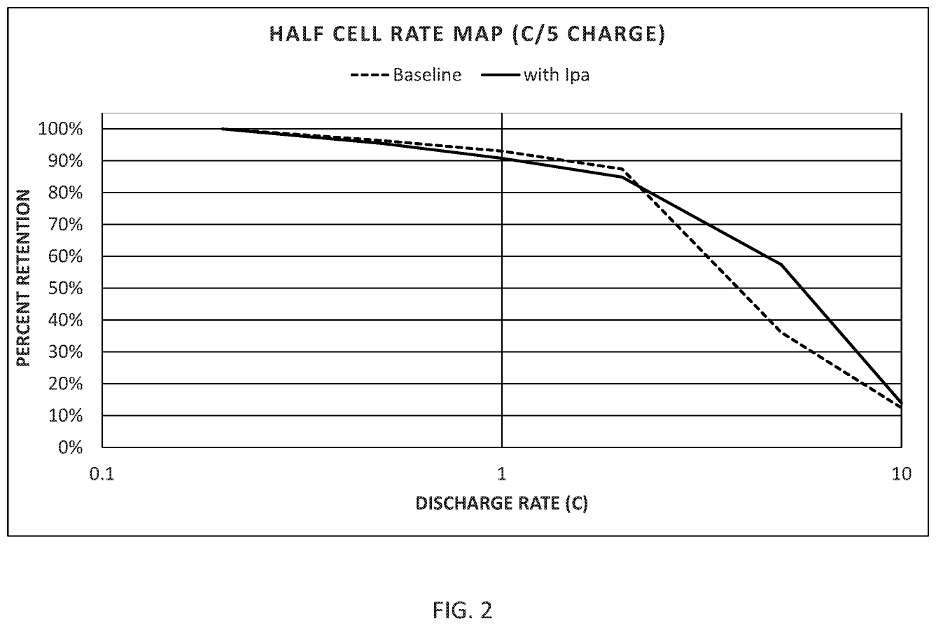

The rate capability of electrodes made using films formed using a liquid processing aid as described herein is comparable to the baseline cell at low rates. In addition, an improvement was seen at rates higher than 2 C. The above produced cathodes were tested in half cells; loading 3.2-3.3 mAh/cm²; cut off voltage 4.2-2.7 V; charged at 0.2 C, discharged at 0.2 C, 0.5 C, 1 C, 2 C, 5 C, 10 C and results are illustrated in FIG. 2. Both baseline and processed in presence of IPA where at a similar porosity and loading.

Micrographs of the surface show that repeated calendering without IPA smooths out the surface of a free standing film and fills in some of the porosity. This surface compaction is reduced when calendered in the presence of IPA thereby increasing resulting porosity. The use of the liquid processing aid also serves to reduce fracture of the electrode film thereby improving cycle life and first cycle reversibility.

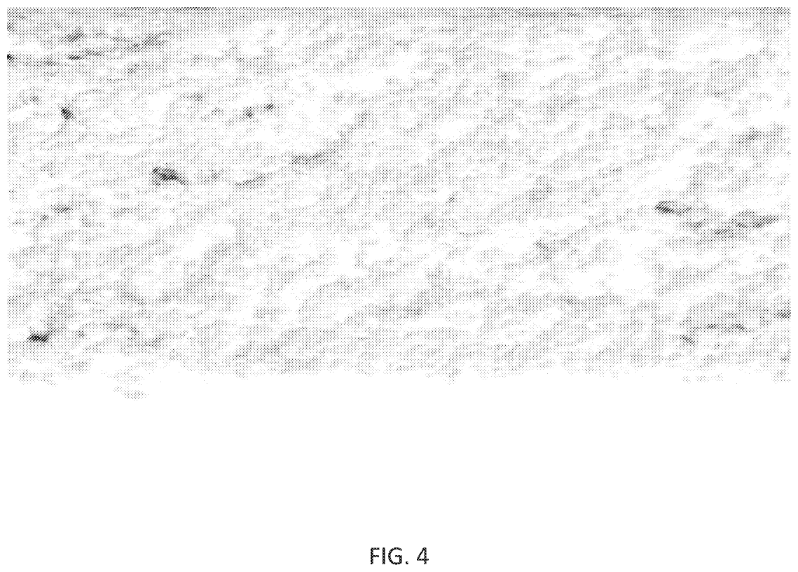

Cross sectional images of the IPA processed film show an even distribution of fluorine across the film, indicating an even distribution of the PTFE binder when films are calendered in the presence of IPA. Results are illustrated in FIG. 4.

Larger format cells can be obtained when processed in presence of processing aid such as IPA without a reduction in film quality or processing time. 47 cm² is the largest format obtained consistently without using IPA wetting step whereas with IPA a film of 162 cm was readily achieved.

Various modifications of the present disclosure, in addition to those shown and described herein, will be apparent to those skilled in the art of the above description. Such modifications are also intended to fall within the scope of the appended claims.

The foregoing description of particular aspect(s) is merely exemplary in nature and is in no way intended to limit the scope of the disclosure, its application, or uses, which may, of course, vary. The materials and processes are described with relation to the non-limiting definitions and terminology included herein. These definitions and terminology are not designed to function as a limitation on the scope or practice of the disclosure, but are presented for illustrative and descriptive purposes only. While the processes or compositions are described as an order of individual steps or using specific materials, it is appreciated that steps or materials may be interchangeable such that the description of the disclosure may include multiple parts or steps arranged in many ways as is readily appreciated by one of skill in the art.

It will be understood that, although the terms “first,” “second,” “third.” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first ‘element’”, “component,” “region,” “layer,” or “section” discussed below could be termed a second (or other) element, component, region, layer, or section without departing from the teachings herein.

The terminology used herein is for the purpose of describing particular aspects of the disclosure only and is not intended to be limiting. As used herein, the singular forms “a.” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

It is appreciated that all reagents are obtainable by sources known in the art unless otherwise specified.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

The foregoing description is illustrative of particular aspects of the disclosure, but is not meant to be a limitation upon the practice thereof.

1. A process for forming a film suitable for use in an electrode, the process comprising:
forming an initial free standing film, the step of forming optionally comprising
a) combining a fibrillizable binder and a solid processing additive (optionally carbon particles) or an active electrode material to form an electrode precursor material;
b) intermixing said electrode precursor material;
c) combining said electrode precursor material with said solid processing additive or said active electrode material; and
d) intermixing said fibrillizable binder or said active electrode material with said electrode precursor material to form an electrode film material wherein said electrode film material comprises said fibrillizable binder, and at least one of said processing additives and said active electrode material;
calendering said electrode film material into an initial free standing film;
contacting said initial free standing film with a liquid processing aid forming a wetted free standing film;
passing said wetted free standing film through a roll mill, wherein said step of passing said wetted free standing film through said roll mill is repeated one or more times until an electrode film is formed, the electrode film comprising a final desired thickness of about 75% or less, optionally 50% or less, optionally 25% or less, relative to the initial free standing film, wherein said step of passing said wetted free standing film through said roll mill requires fewer passes than passing an dry free standing film through said roll mill to form said electrode film comprising said thickness of about 75% or less relative to the initial free standing film.

2. The process of claim 1, wherein said fibrillizable binder and said active electrode material are combined and intermixed to form said electrode precursor material and said electrode precursor material and said processing additive are combined and intermixed to form said electrode film material.

3. The process of claim 1, wherein said fibrillizable binder and said solid processing additive are combined and intermixed to form said electrode precursor material and said electrode precursor material and said solid processing additive are combined and intermixed to form said electrode film material.

4. The process of claim 1, wherein said fibrillizable binder and said active electrode material are combined and intermixed to form said electrode precursor material and said electrode precursor material and said active electrode material are combined and intermixed to form said electrode film material.

5. The process of claim 1, wherein said step of passing said wetted free standing film through said roll mill requires 1 to 10 passes through said roll mill to achieve said thickness of about 100 micrometers or less.

6. The process of claim 1, wherein said step of passing said wetted free standing film through said roll mill requires 1-5 passes through said roll mill to achieve said thickness of about 100 micrometers or less.

7. The process of claim 1, said step of passing said wetted free standing film through said roll mill requires five fewer number of passes than passing said dry free standing film through said roll mill to achieve said thickness of about 400 micrometers or less.

8. The process of claim 1, wherein said electrode film comprises a porosity of about 35% to about 45%.

9. The process of claim 1, wherein said electrode film comprises a Young's modulus of about 9.1 N/mm².

10. The process of any one of claims 1-9, wherein said liquid processing aid is an alcohol.

11. The process of any one of claims 1-9, wherein said liquid processing aid is a solvent, said solvent comprises a surface tension of about 30 dynes/cm or less at 20 degrees Celsius.

12. The process of any one of claims 1-9, wherein said liquid processing aid comprises an evaporation rate of greater than 1.

13. The process of any one of claims 1-9, wherein said liquid processing aid is acetone, dimethyl carbonate, ethyl alcohol, anisole, ethanol, anisole, isopropyl alcohol, or any combination thereof.

14. The process of any one of claims 1-9, wherein said liquid processing aid is isopropyl alcohol.

15. The process of any one of claims 1-9, wherein said step of calendering said electrode film material into said initial free standing film is in an environment of about 130 degree Celsius.

16. The process of any one of claims 1-9, wherein said step of passing said wetted free standing film through said roll mill comprises heating said wetted free standing film to about 50 degree Celsius.

17. The process of claim 16, wherein said heating said wetted free standing film comprises heating with IR heat.

18. The process of any one of claims 1-9, wherein said step of passing said wetted free standing film through said roll mill further comprises:
heating said wetted free standing film to 50 degree Celsius or greater; and
compressing said wetted free standing film with said roll mill at a pressure of about 4000 to about 7000 pounds per square inch.

19. The process of any one of claims 1-9, wherein said roll mill comprises a roll speed of about 0.65 meters per minute.

20. The process of any one of claims 1-9, further comprising laminating said electrode film to an current collector to form said electrode.

21. The process of any one of claims 1-9, wherein said electrode film material comprises a conductive carbon.

22. The process of any one of claims 1-9, wherein said step of intermixing is in the absence of a solvent at an amount greater than 1% by weight.

23. The process of any one of claims 1-9, wherein said electrode film comprises a thickness of 100 micrometers or less, optionally 50 micrometers or less.

24. The process of any one of claims 1-9, wherein said active electrode material is capable of lithiation and delithiation.

25. The process of any one of claims 1-9, further comprising sieving said electrode film material.

26. The process of any one of claims 1-9, wherein said active electrode material comprises a lithium metal oxide, a lithium metal phosphate (optionally lithium manganese iron phosphate), or combinations thereof.

27. The process of any one of claims 1-9, wherein said fibrillizable binder comprises polytetrafluoroethylene.

28. The process of any one of claims 1-9, wherein said electrode film material comprises a single fibrillizable binder, said fibrillizable binder comprising or consisting of polytetrafluoroethylene.

29. An electrochemical cell comprising a cathode comprising said electrode film formed by the process of any one of claims 1-9.

30. An electrochemical cell comprising an anode comprising said electrode film formed by the process of any one of claims 1-9.

31. A process for forming an electrode comprising:
obtaining an electrode film material;
calendering said electrode film material into an initial free standing film;
contacting said initial free standing film with a liquid processing aid forming a wetted free standing film;
passing said wetted free standing film through a roll mill, wherein said step of passing said wetted free standing film through said roll mill is performed one or more times until an electrode film comprising a thickness of about 50% or less, optionally 25% or less, optionally 100 micrometers or less, relative to the initial free standing film is formed, wherein said step of passing said free standing film through said roll mill requires about 1 to 10 fewer passes than passing an initial free standing film absent said liquid processing aid through said roll mill to form said electrode film comprising a thickness of about 50% or less relative to the initial free standing film.

32. The process of claim 31, wherein said step of obtaining said electrode film material further comprises:
combining a fibrillizable binder and carbon particles or an active electrode material to form an electrode precursor material;
intermixing said electrode precursor material;
combining said electrode precursor material with said carbon particles or said active electrode material;
intermixing said fibrillizable binder or said active electrode material with said electrode precursor material to form said electrode film material wherein said electrode film material comprises said fibrillizable binder, and at least one of said carbon particles and said active electrode material.

33. The process of claim 32, wherein said fibrillizable binder and said active electrode material are combined and intermixed to form said electrode precursor material and said electrode precursor material and said carbon particles are combined and intermixed to form said electrode film material.

34. The process of claim 32, wherein said fibrillizable binder and said carbon particles are combined and intermixed to form said electrode precursor material and said electrode precursor material and said carbon particles are combined and intermixed to form said electrode film material.

35. The process of claim 32, wherein said fibrillizable binder and said active electrode material are combined and intermixed to form said electrode precursor material and said electrode precursor material and said active electrode material are combined and intermixed to form said electrode film material.

36. The process of claim 32, wherein repeating said step of passing said wetted free standing film through said roll mill requires three fewer number of passes than passing said dry free standing film through said roll mill to achieve said thickness of about 50% or less.

37. The process of claim 32, wherein repeating said step of passing said wetted free standing film through said roll mill requires four fewer number of passes than passing said dry free standing film through said roll mill to achieve said thickness of about 50% or less.

38. The process of claim 32, wherein repeating said step of passing said wetted free standing film through said roll mill requires five fewer number of passes than passing said dry free standing film through said roll mill to achieve said thickness of about 50% or less.

39. The process of any one of claims 31-38, wherein said liquid processing aid is an alcohol.

40. The process of any one of claims 31-38, wherein said liquid processing aid comprises a surface tension of about 30 dynes/cm or less at 20 degree Celsius.

41. The process of any one of claims 31-38, wherein said liquid processing aid comprises an evaporation rate of greater than 1.

42. The process of any one of claims 31-38, wherein said liquid processing aid is at least one of acetone, dimethyl carbonate, ethyl alcohol, ethanol, anisole, isopropyl alcohol, or combinations thereof.

43. The process of any one of claims 31-38, wherein said liquid processing aid is isopropyl alcohol.

44. The process of any one of claims 31-38, wherein said step of calendering said electrode film material into said initial free standing film is in an environment of about 130 degrees Celsius.

45. The process of any one of claims 31-38, wherein said step of passing said wetted free standing film through said roll mill comprises heating said wetted free standing film to about 50 degree Celsius.

46. The process of claim 45, wherein said heating said wetted free standing film comprises heating with IR heat.

47. The process of any one of claims 31-38, wherein said step of passing said wetted free standing film through said roll mill further comprises:
heating said wetted free standing film to 50 degrees Celsius or greater; and
compressing said wetted free standing film with said roll mill at a pressure of about 4000 to about 7000 pounds per square inch.

48. The process of any one of claims 31-38, wherein step of compressing is at a roll speed of about 0.65 meters per minute.

49. The process of any one of claims 31-38, further comprising laminating said electrode film to a current collector to form said electrode.

50. The process of any one of claims 31-38, wherein said electrode film material comprises a conductive carbon.

51. The process of any one of claims 31-38, wherein said step of intermixing is in the absence of a solvent greater than 1%.

52. The process of any one of claims 31-38, wherein said electrode film comprises a thickness of 100 micrometers or less, optionally 50 micrometers or less.

53. The process of any one of claims 32-38, wherein said active electrode material is capable of lithiation and delithiation.

54. The process of any one of claims 31-38, further comprising sieving said electrode film material.

55. The process of any one of claims 32-38, wherein said active electrode material comprises a lithium metal oxide, a lithium metal phosphate (optionally lithium manganese iron phosphate), or combinations thereof.

56. The process of any one of claims 32-38, wherein said fibrillizable binder comprises polytetrafluoroethylene.

57. The process of any one of claims 32-38, wherein said electrode film material comprises a single fibrillizable binder, said fibrillizable binder comprising or consisting of polytetrafluoroethylene.

58. An electrochemical cell comprising a cathode comprising said electrode film formed by a process of any one of claims 31-38.

59. An electrochemical cell comprising an anode comprising said electrode film formed by a process of any one of claims 31-38.
